(19) United States
(12) Patent Application Publication
(10) Pub. No.: US 2008/0264751 A1
(43) Pub. Date: Oct. 30, 2008

(54) Drive Configuration for Cableways and Brake and Clutch Unit Therefor

(75) Inventors: Peter Bohm, Unna (DE); Clemens Witt, Hamm (DE); Thomas Muller, Hagen (DE)

Correspondence Address: LERNER GREENBERG STEMER LLP, P O BOX 2480, HOLLYWOOD, FL, 33022-2480, US

(73) Assignee: STROMAG AG, Unna (DE)

(21) Appl. No.: 12/109,026

(22) Filed: Apr. 24, 2008

(30) Foreign Application Priority Data
Apr. 24, 2007 (DE) DE 202007006169.2

(51) Int. Cl. F16D 67/06; F16D 13/52

(52) U.S. Cl. 192/18 B; 192/18 R; 192/70.11

(57) ABSTRACT

A brake and clutch unit for mounting on a main shaft of a drive configuration of a cableway, includes a drive section which can be subjected to a drive torque, a hub which can be connected in a rotationally fixed manner to the main shaft and a base section which can be fastened in a positionally fixed manner. A switchable clutch is provided between the drive section and the hub and a switchable brake is provided between the base section and the hub. The switchable clutch is constructed as a friction clutch. A drive configuration for a cableway is also provided.

### CROSS-REFERENCE TO RELATED APPLICATION

This application claims the priority, under 35 U.S.C. §119, of German Patent Application DE 20 2007 006 169.2, filed Apr. 24, 2007; the prior application is herewith incorporated by reference in its entirety.

### BACKGROUND OF THE INVENTION

### Field of the Invention

The invention relates to a drive configuration for a cableway, including a main shaft, a carrying wheel connected in a rotationally fixed manner to the main shaft, a drive wheel, preferably constructed as a belt pulley, which can be connected in a rotationally fixed manner to the main shaft, and a switchable clutch for the rotationally fixed connection of the main shaft to the drive wheel. Furthermore, the invention relates to a brake and clutch unit for mounting on a main shaft of a drive configuration of a cableway, including a drive section which can be subjected to a drive torque, a hub which can be connected in a rotationally fixed manner to the main shaft, and a base section which can be fastened in a positionally fixed manner, wherein a switchable clutch is provided between the drive section and the hub, and a switchable brake is provided between the base section and the hub.

Drive configurations of that type are used in cableway systems in the region of cableway stations. Whereas cableway gondolas are driven between the stations by a traction cable or a combined carrying and traction cable, within the stations they are driven through the use of such drive configurations. A plurality of such drive configurations are disposed in a row for that purpose. When entering the station, the cableway gondolas are each set down by way of a carrying section onto the carrying wheels of the drive configurations and are conveyed further within the station, while being driven by those configurations. At the same time, a connection with the traction cable is generally interrupted, which means that the movement of the gondola present in the station can be retarded to allow the passengers to get in and out while the other gondolas of the cableway continue to run at the same time. The gondola is then accelerated again by the carrying wheels and finally coupled again to the traction cable. The carrying wheels of the drive configurations can be driven by a drive wheel, preferably a belt pulley which is driven through a corresponding belt. In the case of the drive configurations known from the prior art, uncoupling between the carrying wheel and the drive is brought about through the use of a switchable toothed or claw clutch in order to uncouple a gondola from the drive of the drive configuration for the purpose of stopping the gondola. However, when recoupling for the purpose of accelerating the cableway gondolas, such toothed or claw clutches lead to a very hard coupling engagement or require that the drive has to be braked beforehand in order to allow a gentle start-off movement. Those aspects in conjunction with the coupling engagement are considered to be disadvantageous.

### BRIEF SUMMARY OF THE INVENTION

It is accordingly an object of the invention to provide a drive configuration for a cableway and a clutch and brake unit for such a drive configuration, which overcome the hereinafore-mentioned disadvantages of the heretofore-known devices of this general type and which allow a simplified and more comfortable operation.

With the foregoing and other objects in view there is provided, in accordance with the invention, a brake and clutch unit for mounting on a main shaft of a drive configuration of a cableway. The brake and clutch unit comprises a drive section to be subjected to a drive torque, a hub to be connected in a rotationally fixed manner to the main shaft, a base section to be fastened in a positionally fixed manner, a switchable friction clutch disposed between the drive section and the hub, and

a switchable brake disposed between the base section and the hub.

Such a friction clutch makes it possible for the main shaft and therefore the carrying wheel of the drive configuration to be coupled even at high speeds of the drive section or of the drive wheel connected to the drive section, without the gondola, which is resting on the carrying wheel, being exposed in an uncomfortable manner to jerky and hard acceleration. Instead, it is possible, by gradually applying a coupling force, to obtain a slowly increasing frictional engagement between the drive section and the main shaft that satisfies the requirements of comfortable passenger transport. It is particularly advantageous that the drive section can run at constantly high rotational speeds and does not have to be retarded for the purpose of the coupling engagement. Typical rotational speeds in the application area of the brake and clutch unit according to the invention are 50 to 100 revolutions per minute. This results in a simple drive-side structure in which drive configurations can be driven by a common main drive which drives all of the drive sections uniformly, without a defined response being required on the part of the main drive to specific operating situations in connection with incoming or outgoing cableway gondolas.

The drive section of the brake and clutch unit is preferably constructed in such a way that it can be connected to the drive wheel. However, the invention also covers embodiments in which the drive section itself directly includes the drive wheel, with the result that the drive wheel is part of the brake and clutch unit.

In accordance with another feature of the invention, the hub, which can be connected in a rotationally fixed manner to the main shaft, is preferably formed in one part. This hub can be composed of a plurality of hub sections which are connected to one another.

In accordance with a further feature of the invention, the brake and clutch unit or combination preferably has an armature disk which can move axially with respect to the drive section and the hub. This armature disk produces a frictional engagement of the brake in a first axial end position and produces a frictional engagement of the switchable clutch in its second end position. In such a configuration, the armature disk is accordingly responsible, depending on its axial position, either for a braking action on the main shaft or for a driving action on the main shaft. Only very simple activating devices are therefore required for switching the clutch and the brake, since it is not necessary to provide separate activating devices. Moreover, this also ensures that a braking and driving action do not occur on the main shaft at the same time. The frictional engagement of the brake is preferably produced as a result of the armature disk, which rotates together with the main shaft, being pressed itself against the fixed base section. It is also possible to provide friction linings on the base section and/or on the armature disk so as to thereby influence the frictional action of the brake in a controlled manner. With regard to the clutch, a configuration is conceivable in which a friction surface for direct contact with a friction surface of the drive section is provided directly on that side of the armature disk facing away from the brake.

In accordance with an added feature of the invention, however, it is preferable if the switchable clutch is constructed as a multi-plate clutch, wherein preferably outer plates are connected in a rotationally fixed manner to the drive section and inner plates are connected in a rotationally fixed manner to the hub, and wherein preferably an actuating section of the armature disk is constructed as an actuating device of the multi-plate clutch for applying an axially acting actuating force to the plates. The use of a multi-plate clutch affords a very compact structure while allowing high torques to be transmitted at the same time. Actuation preferably occurs by the plate assembly being compressed by an actuating section of the armature disk.

In accordance with an additional feature of the invention, particular preference is given to a brake and clutch unit or combination in which the hub is fixed axially with respect to the base section, preferably by virtue of a rotary bearing being provided between the hub and the base section. This bearing acts as a thrust bearing and is fixed axially on the hub side and on the base section side. According to this development, the hub is fixed with respect to the base section even when the brake and clutch unit is in the non-mounted state. This means that a preadjustment of the switchable brake, in particular with regard to its air gap, is possible on the part of the manufacturer of the brake and clutch unit and does not have to be performed later after this unit has been installed. Furthermore, the specified configuration of the rotary bearing also means that there is no necessity to provide a device on the main shaft for accommodating the bearings between the base section and the main shaft. Instead, the main shaft has only to be brought into a rotationally fixed connection with the hub, for example through a feather key. The axial relative position between the base section and the main shaft or between the hub and the main shaft is unimportant for the air gap of the brake. A brake and clutch unit according to this development constitutes a particularly advantageous attachment-ready unit which requires only little technical skill on the part of whomever will use the unit.

In accordance with yet another feature of the invention, the brake and the clutch can be constructed either as a pole wheel brake or as a pole wheel clutch in which corresponding metal surfaces produce the frictional engagement in each case. However, they can respectively also be provided with brake or clutch linings which allow a targeted influence on the frictional action and which can moreover be constructed to be interchangeable.

In accordance with yet a further feature of the invention, the friction disks or plates of the clutch or of the brake are fabricated from stainless steel or have sections made of stainless steel at least in the region of friction surfaces. Such a structure of the clutch and the brake is particularly advantageous in connection with cableway vehicles, since the risk of wear due to penetrating moisture is comparatively high especially in ski regions in which brake and clutch units according to the invention will be used primarily.

In accordance with yet an added feature of the invention, particular preference is given to brake and clutch units in which a peripheral gap region between the drive section and the armature disk, between the armature disk and the base section and/or between the drive section and the base section is protected from the penetration of dirt and moisture by sealing elements and/or sealing geometries.

Such a structure of the gap regions provides effective protection for the comparatively sensitive components of the brake and clutch without a separate housing having to be provided. This is advantageous with respect to overall size and manufacturing costs. The sealing geometries are preferably obtained by shaping the components, that is to say the drive section, the base section and/or the armature disk. In accordance with yet an additional feature of the invention, this shaping preferably includes peripheral grooves and webs which jointly act as a labyrinth seal. Depending on the specific use conditions, it is particularly advantageous for such a labyrinth seal not to prevent condensation and water that has previously penetrated from running off, since it is constructed not be to be liquid-tight.

In accordance with again another feature of the invention, particularly between components constructed to be rotatable relative to one another, such as for example, in the transition region between the drive section on one hand and the base section or armature disk on the other hand, a sealing geometry is considered to be advantageous in which a groove that is open in the axial direction is provided in one of the components and a peripheral web which engages in the axial groove is provided on the component situated opposite. The groove and the web then together form a labyrinth seal which can effectively prevent the penetration of dirt. An increase in reliability is possible by providing a plurality of grooves and webs. In addition or as an alternative, elastic sealing elements can also be provided between the components which are rotatable relative to one another.

In accordance with again a further feature of the invention, an alternative sealing geometry provides that an axially extending peripheral sealing collar is provided on a first component. This collar at least partially covers a circumferential surface of a second component for the purpose of sealing an intervening gap. Preferably a peripheral sealing element is provided between the circumferential surface of the second component and the sealing collar. The sealing collar is preferably formed as a separate component and connected to the first component. However, it can also be formed in one piece on the first component. The peripheral and axially extending gap between the circumferential surface of the second component and the sealing collar can be effectively sealed through the use of a peripheral sealing element, such as for example, a felt strip.

In accordance with again an added feature of the invention, preferably, the brake and clutch unit is constructed in such a way that the brake and the switchable clutch can be switched by a common activating device, wherein the activating device is preferably an electromagnetically acting coil. This can be achieved in a particularly simple way if, in the manner described above, an armature disk is provided which can be influenced in its position by the coil and which, depending on the axial end position it has just adopted, produces both the braking action and the clutch action. In one direction opposed to the movement of the armature disk resulting from the activation of the activating device, the armature disk is preferably subjected to force through the use of spring elements.

In accordance with again an additional feature of the invention, the activating device is preferably constructed in such a way that, in an activated state, it causes the clutch to be uncoupled and the brake to be activated and, in a deactivated state, it causes the clutch to be coupled and the brake to be released. Activating the activating device, for example by energizing it with current, is therefore only required if the uncoupled state is to be obtained. In the case of the use according to the invention in a cableway, this occurs when a gondola is to be braked. In this development, energizing the activating device with current or activating it in some other way is therefore only required if it is intended to brake the gondola.

With the objects of the invention in view, there is also provided a drive configuration for a cableway. The drive configuration comprises a main shaft, a carrying wheel connected in a rotationally fixed manner to the main shaft, a drive wheel, in particular a belt pulley, to be connected in a rotationally fixed manner to the main shaft, and a switchable friction clutch, preferably a multi-plate clutch, preferably having plates made of stainless steel, for a rotationally fixed connection of the main shaft to the drive wheel.

In accordance with another feature of the invention, in this case, a friction brake is preferably additionally provided. The friction clutch and the friction brake are particularly preferably constructed as a common brake and clutch unit according to the invention.

In accordance with a concomitant feature of the invention, particular preference is given in this case to a configuration in which the drive wheel is directly connected in a rotationally fixed manner to the drive section of the clutch.

Other features which are considered as characteristic for the invention are set forth in the appended claims.

Although the invention is illustrated and described herein as embodied in a drive configuration for cableways and a brake and clutch unit therefor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a brake and clutch unit according to the invention; and

FIG. 2 is a longitudinal-sectional view of the brake and clutch unit of FIG. 1 in an intended installed condition.

### DETAILED DESCRIPTION OF THE INVENTION

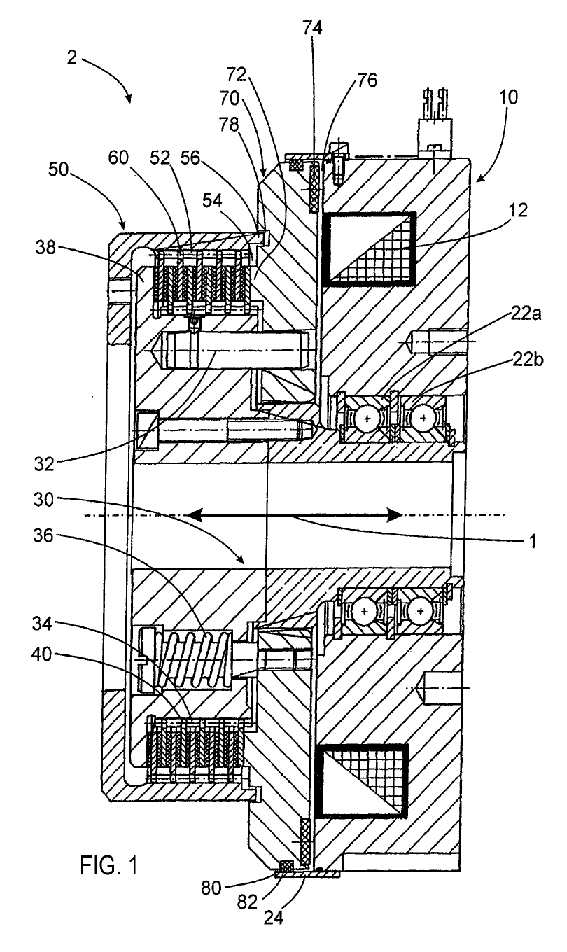

Referring now to the figures of the drawings in detail and first, particularly, to FIG. 1 thereof, there is seen a brake and clutch unit 2 according to the invention. The brake and clutch unit 2 includes four main assemblies which can move relative to one another. These main assemblies include:
a base section 10 which is constructed for positionally fixed fastening, for example to a carrier intended for a plurality of drive configurations of that type,
a hub 30 which is constructed for rotationally fixed connection to a non-illustrated main shaft,
a drive section 50 which is intended for rotationally fixed connection to a non-illustrated drive wheel, and
an armature disk 70 which is disposed between the base section 10 on one hand and the drive section 50 and the hub 30 on the other hand.

A bearing configuration including two ball bearings 22a, 22b is disposed between the base section 10 and the hub 30, which is formed in two parts. The ball bearings are retained in a respective axially defined position through the use of securing rings, with the result that, in the direction of a main axis 1, the base section and the hub 30 have a defined and non-variable position with respect to one another. However, the base section 10 and the hub section 30 are able to rotate relative to one another about the main axis 1.

The armature disk 70 is held in a rotationally fixed position with respect to the hub 30 through the use of cylindrical pins 32. However, the armature disk 70, guided by the cylindrical pins 32, is able to move translationally with respect to the hub 30 and the base section 10 in the direction of the main axis 1.

A total of five outwardly directed inner plates 40 are slipped onto outer sides of the hub 30 and secured in a rotationally fixed manner through the use of axial webs 34. These inner plates 40 are able to move translationally to a limited extent with respect to the hub section 30, but not rotationally. In a corresponding way to the inner plates 40, inwardly directed outer plates 60 are provided on the drive section 50. These outer plates 60 are likewise connected in a rotationally fixed manner to the drive section 50 through the use of axial webs 52. In an as-supplied state represented in FIG. 1, the inner plates 60 and the outer plates 40 already form a plate assembly including an alternating configuration of inner plates 40 and outer plates 60. In the as-supplied state, the drive section 50 is not in a defined position with respect to the hub 30. Coaxiality is obtained only when mounting the drive section on a drive wheel.

The armature disk 70 is capable of axial translational movement with respect to the base section 10 and the hub 30. In the as-supplied state represented, the armature disk is pulled in the direction of the drive section 50 and the hub 30 through the use of helical springs 36. The resulting axial end position of the armature disks 70 represented in FIG. 1 is thus associated with the fact that an actuation section 72 of the armature disks 70 pushes axially onto the plate assembly which is formed of the inner plates 60 and the outer plates 40, and presses this assembly against an opposed section 38 of the hub 30. This state represents a coupling state in which the hub 30 and the drive section 50 are rotationally fixed relative to one another.

In order to release this coupled state, a coil 12 is provided in the base module and, when energized with current, pulls the armature disk 70 through the use of a magnetic field against the spring force of the springs 36 in the direction of the base section 10. This results in the clutch being released since the actuating section 72 of the armature disk 70 no longer pushes onto the plate assembly made up of the plates 40, 60. However, a frictional engagement between the armature disk 70 and the base section 10 occurs on the opposite side, due to a friction lining 74, which bears against the base section 10, being provided on the armature disk 70. As a result, a frictional engagement is caused between the armature disk 70 and the base section 10 that leads to a braking of the armature disk 70, the hub 30 and therefore the main shaft (which is not shown in FIG. 1).

As soon as the energization of the coil 12 with current ceases, the armature disk 70 is once again pulled by the helical springs 36 in the direction of the drive section 50 and thereby once again produces the frictional engagement in the clutch.

In order to prevent the penetration of dirt, gap regions 54, 76 between the drive section 50 and the armature disk 70 and between the armature disk 70 and the base section 10 are respectively provided with specific protection. The gap region 54 between the drive section 50 and the armature disk 70 is protected through the use of a labyrinth seal which is formed by a peripheral groove 78 in the armature disk 70 that is open in the axial direction and by a corresponding web 56 of the drive section 50 that engages in the peripheral groove 78.

A protective collar 24, which is fastened to the base section 10 and projects over the armature disk 70, is provided in the gap region 76 between the armature disk 70 and the base section 10. A gap 80 between the armature disk 70 and the protective collar 24 is closed by a felt strip 82.

These sealing elements and geometries between the drive section 50, the armature disk 70 and the base section 10 ensure that the amount of impure matter and/or moisture which penetrates is reduced to a minimum. At the same time, there is no need in this case for any additional measures such as, for example, a uniform protective housing which would make handling more difficult, increase overall size and increase manufacturing cost and effort.

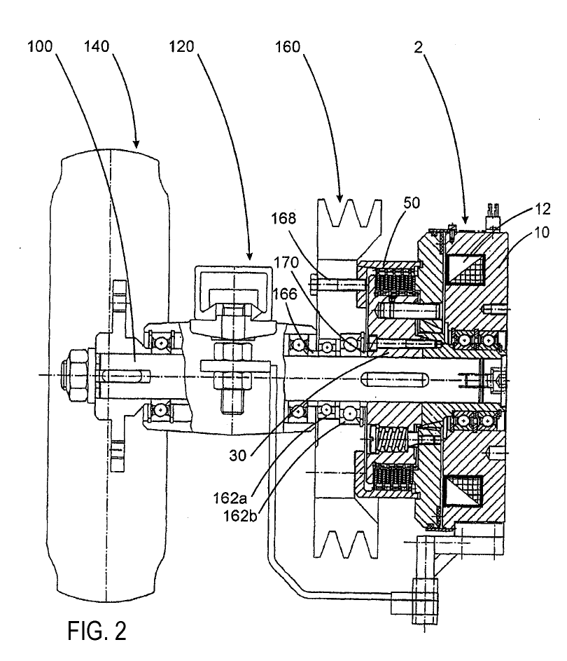

FIG. 2 shows the brake and clutch unit 2 of FIG. 1 in its installed condition in the context of a complete drive configuration for a cableway. Apart from the brake and clutch unit 2, this drive configuration additionally includes a main shaft 100, a positionally fixed guide sleeve 120 for the main shaft 100 and a carrying wheel 140. The carrying wheel 140 is disposed on one side of the guide sleeve 120 and a drive wheel 160, constructed as a belt pulley, on the opposite side of the guide sleeve 120.

The carrying wheel 140 is connected in a rotationally fixed manner to the main shaft 100. The drive wheel 160, by contrast, is constructed in such a way that it can rotate with respect to the main shaft 100 through the use of two ball bearings 162a, 162b. The axial position of the drive wheel 160 with respect to the guide sleeve 120 is ensured by a first spacer sleeve 166 which is slipped onto the main shaft 100.

A second spacer sleeve 170 is provided between the ball bearing 162b and the hub 30. This results in a defined spacing between the hub 30 and belt pulley 160. Since the drive section 50 is mounted in a defined position on the belt pulley 160 through the use of screws 168, a defined axial position between the hub 30 and the drive section 50 is thus also achieved, which means that additional adjustments for aligning the components which can be coupled by the clutch are not required.

In a manner which has not been represented, the base section 10 of the brake and clutch unit 2 is fastened in a positionally fixed manner, for example to a carrier provided for this purpose.

After the drive section 50 has been mounted on the belt pulley 160 and the base section 10 has been mounted on the carrier provided for this purpose, no further adjustment operations need to be performed.

In its intended installed condition which is represented in FIG. 2, the brake and clutch combination makes it possible, by energizing the coil 12 with current, to uncouple the drive wheel 160 from the main shaft 100 and subsequently brake the main shaft 100 and therefore the carrying wheel 140. Upon interrupting the energization, the braking action is discontinued and the multi-plate clutch is returned to its coupled state in which, by virtue of frictional engagement, torque transmission between the drive wheel 160 and the carrying wheel 140 takes place through the main shaft 100.

During operation, after a cableway gondola has entered a station, the drive configurations are first uncoupled and braked by energizing the coil 12 until the cableway gondola has come to a stop or reached a desired speed for letting passengers in and out. The main shaft together with the carrying wheel is then recoupled to the drive wheel 160 by interrupting the energization of the coil 12 in such a way that the drive wheel again accelerates the departure-ready cableway gondola.

1. A brake and clutch unit for mounting on a main shaft of a drive configuration of a cableway, the brake and clutch unit comprising:
a drive section to be subjected to a drive torque;
a hub to be connected in a rotationally fixed manner to the main shaft;
a base section to be fastened in a positionally fixed manner;
a switchable friction clutch disposed between said drive section and said hub; and
a switchable brake disposed between said base section and said hub.

2. The brake and clutch unit according to claim 1, wherein said hub is formed in one part.

3. The brake and clutch unit according to claim 1, which further comprises an armature disk movable axially relative to said drive section and said hub, said armature disk producing a frictional engagement of said brake in a first axial end position and producing a frictional engagement of said switchable clutch in a second axial end position.

4. The brake and clutch unit according to claim 3, wherein said switchable clutch is a multi-plate clutch having outer plates and inner plates, said outer plates are connected in a rotationally fixed manner to said drive section and said inner plates are connected in a rotationally fixed manner to said hub, and said armature disk has an actuating section constructed as an actuating device of said multi-plate clutch for applying an axially acting actuating force to said plates.

5. The brake and clutch unit according to claim 1, wherein said hub is fixed axially relative to said base section.

6. The brake and clutch unit according to claim 1, which further comprises a rotary bearing disposed between said hub and said base section, said rotary bearing being fixed axially on a hub side and on a base section side.

7. The brake and clutch unit according to claim 1, wherein at least one of said switchable brake or said switchable friction clutch has at least one lining.

8. The brake and clutch unit according to claim 1, wherein said clutch has friction disks or plates formed of stainless steel or sections made of stainless steel at least in vicinity of friction surfaces.

9. The brake and clutch unit according to claim 1, wherein said switchable brake has a disk formed of stainless steel or sections made of stainless steel at least in vicinity of friction surfaces.

10. The brake and clutch unit according to claim 3, which further comprises at least one of sealing elements or sealing geometries preventing penetration of dirt and moisture into a peripheral gap region between at least one of said drive section and said armature disk, said armature disk and said base section or said drive section and said base section.

11. The brake and clutch unit according to claim 10, wherein said sealing geometries include a peripheral groove on a first component being open in axial direction and a peripheral web on a second component being engaged in said groove.

12. The brake and clutch unit according to claim 10, wherein said sealing geometries include a peripheral, axially extending sealing collar on a first component at least partially covering a circumferential surface of a second component, and a peripheral sealing element disposed between said circumferential surface and said sealing collar.

13. The brake and clutch unit according to claim 1, which further comprises a common activating device for switching said switchable brake and said switchable clutch.

14. The brake and clutch unit according to claim 13, wherein said activating device includes an electromagnetically acting coil.

15. The brake and clutch unit according to claim 13, wherein said activating device, in an activated state, causes said switchable clutch to be uncoupled and said switchable brake to be activated and, in a deactivated state, causes said switchable clutch to be coupled and said switchable brake to be released.

16. A drive configuration for a cableway, the drive configuration comprising:
a main shaft;
a carrying wheel connected in a rotationally fixed manner to said main shaft;
a drive wheel to be connected in a rotationally fixed manner to said main shaft; and
a switchable friction clutch for a rotationally fixed connection of said main shaft to said drive wheel.

17. The drive configuration for a cableway according to claim 16, wherein said switchable friction clutch is a multi-plate clutch.

18. The drive configuration for a cableway according to claim 17, wherein said multi-plate clutch has plates made of stainless steel.

19. The drive configuration for a cableway according to claim 16, wherein said drive wheel is a belt pulley.

20. The drive configuration for a cableway according to claim 16, which further comprises a switchable friction brake, said switchable friction clutch and said switchable friction brake together forming a common brake and clutch unit including a drive section to be subjected to a drive torque, a hub to be connected in a rotationally fixed manner to said main shaft, and a base section to be fastened in a positionally fixed manner, said switchable friction clutch being disposed between said drive section and said hub, and said switchable brake being disposed between said base section and said hub.

21. The drive configuration according to claim 20, wherein said drive wheel is directly connected in a rotationally fixed manner to said drive section of said switchable friction clutch.
